(19) United States
(12) Patent Application Publication
(10) Pub. No.: US 2025/0278642 A1
(43) Pub. Date: Sep. 4, 2025

(54) PARAPHRASE AND AGGREGATE WITH LARGE LANGUAGE MODELS FOR IMPROVED DECISIONS

(71) Applicant: SAMSUNG ELECTRONICS CO., LTD., Suwon-si (KR)

(72) Inventors: Suhel Jaber, San Jose, CA (US); Brendon Christopher Beachy Eby, Chicago, IL (US); Anil Sunder Yadav, San Jose, CA (US)

(73) Assignee: SAMSUNG ELECTRONICS CO., LTD., Suwon-si (KR)

(21) Appl. No.: 19/065,825

(22) Filed: Feb. 27, 2025

Related U.S. Application Data
(60) Provisional application No. 63/560,931, filed on Mar. 4, 2024.

(51) Int. Cl. G06N 5/02

(52) U.S. Cl. CPC G06N 5/02

(57) ABSTRACT

A method of virtual assistance may include, using at least one processor: obtaining an input from a user of a device; selecting at least one node from a knowledge graph (KG) based on the input; generating an input embedding based on the at least one node and the input; encoding the input embedding to generate an output embedding; updating a status of a context and conversation history cache (CCH) based on the output embedding; generating a response based on the status, using a machine learning (ML) model; decoding the response to generate at least one of a verbal output or software action; and performing the at least one of the verbal output or the software action.

### CROSS REFERENCE TO RELATED APPLICATION

This application claims priority from U.S. Provisional Patent Application No. 63/560,931, filed with the United States Patent and Trademark Office on Mar. 4, 2024, the disclosure of which is incorporated herein by reference in its entirety.

### BACKGROUND

### 1. Field

The disclosure concerns artificial intelligence (AI) and large language models (LLM). More specifically, the disclosure concerns an LLM-based virtual assistant.

### 2. Description of Related Art

LLMs (Large Language Models) have generated widespread attention in the last year because of their extraordinary ability to generate natural language to describe almost any topic. This generated text is convincing and can flow naturally incorporating the conversational history into each turn.

Unfortunately, as the content that is generated is mostly based on statistical probability, it may or may not be based on facts, and can be unpredictable. This presents issues when attempting to use LLMs as part of a backend of a virtual assistant.

Unpredictable answers can be incorrect or offensive to users, and a liability to service providers.

### SUMMARY

There are some limitations to the current LLM architectures that limit their reliability and capacity, especially when used in a production environment by a company that wishes to maintain a user experience consistent with their guiding principles and positioning.

Specifically, Large Language Models are not inherently grounded in facts, and instead may generate content that looks correct, but is in fact made up. This is known as Hallucination. It is notoriously difficult to ensure that the content generated by LLMs follows the guidelines desired by their creators. While there have been many attempts at limiting LLM outputs to prevent undesirable content, most current approaches rely on post-processing to flag and remove content as it is generated, rather than preventing the content from emerging in the first place. When creating a personal assistant, the assistant must be able to take actions to interact with its environment in addition to generating language. To a greater extent, when creating a personal assistant it is necessary to ensure that the actions taken and responses generated by the model are logically consistent, and follow the patterns required by the company.

Consequently, there has been great interest in creating architectures that not only maintain the capabilities of existing models, but also generate rooted and aligned content that can provide a consistent user experience.

According to one or more example embodiments, a method of virtual assistance may include, using at least one processor: obtaining an input from a user of a device; selecting at least one node from a knowledge graph (KG) based on the input; generating an input embedding based on the at least one node and the input; encoding the input embedding to generate an output embedding; updating a status of a context and conversation history cache (CCH) based on the output embedding; generating a response based on the status, using a machine learning (ML) model; decoding the response to generate at least one of a verbal output or software action; and performing the at least one of the verbal output or the software action.

The ML model may be trained using reinforcement learning (RL).

The input may be a user action, and decoding the response may generate the software action.

The method may further include selecting the software action using a response action graph, based on the response.

The encoding the input embedding and decoding the response may be performed by a least one neural network.

The method may further include: decoding the status of the CCH to generate a CCH embedding; and encoding the CCH embedding. The response may be generated based on the encoded CCH embedding.

The KG may be personalized to the user.

The method may further include obtaining a user-specific embedding from a user-embedding cache. The updating of the status of the CCH may be based on the user-specific embedding, and the response may be generated based on the user-specific embedding.

The software action may be execution of a process in response to the input.

The method may further include determining, based on the input, that the process would address a need of the user; and executing the process.

According to one or more example embodiments, a system for providing virtual assistance may include at least one server that may include: at least one communication interface; at least one processor; and at least one memory storing instructions, that when executed by the at least one processor, cause the at least one processor to: obtain an input from a user of a device, using the at least one communication interface; select at least one node from a knowledge graph (KG) based on the input; generate an input embedding based on the at least one node and the input; encode the input embedding to generate an output embedding; update a status of a context and conversation history cache (CCH) based on the output embedding; generate a response based on the status, using a machine learning (ML) model; decode the response to generate at least one of a verbal output or software action; and send the verbal output or instructions to perform the software action to the device using the at least one communication interface.

The ML model may be trained using reinforcement learning (RL).

The input may be a user action, and decoding the response may generate the software action.

The method may further include selecting the software action using a response action graph, based on the response.

The encoding the input embedding and decoding the response may be performed by a least one neural network.

The method may further include: decoding the status of the CCH to generate a CCH embedding; and encoding the CCH embedding. The response may be generated based on the encoded CCH embedding.

The KG may be personalized to the user.

The method may further include obtaining a user-specific embedding from a user-embedding cache. The updating of the status of the CCH may be based on the user-specific embedding, and the response may be generated based on the user-specific embedding.

The software action may be execution of a process in response to the input.

The method may further include determining, based on the input, that the process would address a need of the user; and executing the process.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system according to one or more embodiments;

FIG. 2 is a block diagram of a method according to one or more embodiments;

FIG. 3 is a block diagram of a method according to one or more embodiments;

FIG. 4 is a block diagram of a method according to one or more embodiments;

FIG. 5 is a block diagram of a method according to one or more embodiments;

FIG. 6 is a block diagram of a method according to one or more embodiments;

FIG. 7 is a block diagram of a method according to one or more embodiments;

FIG. 8 is a block diagram of a method according to one or more embodiments;

FIG. 9 is a flow chart of a method according to one or more embodiments;

FIG. 10 is a flow chart of a method according to one or more embodiments;

FIG. 11 is a flow chart of a method according to one or more embodiments; and

FIG. 12 is a flow chart of a method according to one or more embodiments.

### DETAILED DESCRIPTION

Hereinafter, the disclosure is described in detail with reference to the accompanying drawings.

General terms that are currently widely used are selected as possible as terms used in embodiments of the disclosure in consideration of their functions in the disclosure, and may be changed based on the intention of those skilled in the art or a judicial precedent, the emergence of a new technique, or the like. In addition, in a specific case, terms arbitrarily chosen by an applicant may exist. In this case, the meanings of such terms are described in detail in corresponding descriptions of the disclosure. Therefore, the terms used in the disclosure need to be defined based on the meanings of the terms and the content throughout the disclosure rather than simple names of the terms.

In the disclosure, an expression “have,” “may have,” “include,” “may include,” or the like, indicates the existence of a corresponding feature (for example, a numerical value, a function, an operation, or a component such as a part), and does not exclude the existence of an additional feature.

Expressions, “at least one of A and B” and “at least one of A or B” and “at least one of A or B” should be interpreted to mean any one of “A” or “B” or “A and B.” As another example, “performing at least one of steps 1 and 2” or “performing at least one of steps 1 or 2” means the following three juxtaposition situations: (1) performing step 1; (2) performing step 2; (3) performing steps 1 and 2. Expressions “first,” “second,” and the like, used in the specification may indicate various components regardless of the sequence and/or importance of the components. These expressions are used only to distinguish one component from another component, and do not limit the corresponding components.

When any component (for example, a first component) is mentioned to be “(operatively or communicatively) coupled with/to” or “connected to” another component (for example, a second component), it is to be understood that any component may be directly coupled to another component or may be coupled to another component through still another component (for example, a third component).

A term of a singular number may include its plural number unless explicitly indicated otherwise in the context. It is to be understood that a term “include,” “formed of,” or the like used in the application specifies the presence of features, numerals, steps, operations, components, parts, or combinations thereof, mentioned in the specification, and does not preclude the presence or addition of one or more other features, numerals, steps, operations, components, parts, or combinations thereof.

Elements described as “modules” or “part” may be physically implemented by analog and/or digital circuits including one or more of a logic gate, an integrated circuit, a microprocessor, a microcontroller, a memory circuit, a passive electronic component, an active electronic component, and the like.

In the specification, such a term as a “user” may refer to a person who uses an electronic apparatus or an apparatus (for example, an artificial intelligence electronic apparatus) which uses an electronic apparatus.

### Hardware

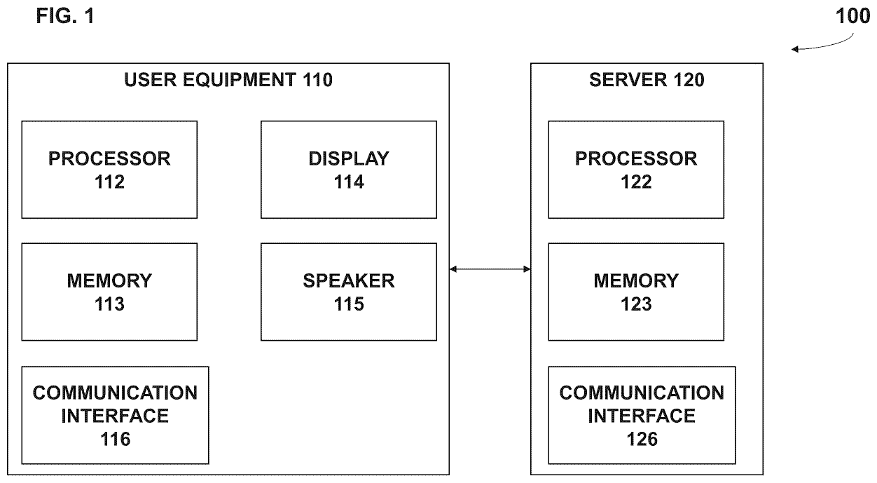

FIG. 1 is a block diagram of a system 100 according to one or more embodiments. The system 100 includes user equipment (UE) 110, which may include at least one processor 112 and at least one memory 113. The at least one memory 113 may store instructions or software configured to cause the at least one processor 112 to perform the methods described herein. The UE 110 is connected with server 120.

The server 120 may be a dedicated computing device communicating over a network with several user devices. The server 120 may be implemented by a plurality of servers, server units, or sub-servers (i.e. more than one computer) that may be directly connected electronically or connected over a network. The UE 110 or the server 120 may also be a server, smartphone, personal computer, wearable, tablet, or other suitable device. In some embodiments, the UE 110 includes display 114 and speaker 115 to output e.g. responses to user inquiries to a user. In some embodiments, the UE 110 includes communication interface 116, and obtains an input and sends an output via communication interface 116. The communication interface 116 may be used to communicate with e.g. the server 120.

The server 120 may include a processor 122, and memory 123, and a communication interface 126. The at least one memory 123 may store instructions or software configured to cause the at least one processor 122 to perform the methods described herein. The server 120 may communicate with the UE 110 and other devices using communication interface 126.

Embodiments herein provide a virtual assistance system and method. These can be implemented on a UE 110 or server 120 alone, or with both of these devices acting in concert. For example, the UE 110 may accept inputs (e.g. queries) from a user, and forward those queries using communication interface 116 to server 120 for processing. Server 120 may implement a machine learning (ML) model or large language model (LLM) using the at least one processor 122 and at least one memory 123. Server 120 may generate a response to the input and forward the response to the UE 110 using communication interface 126. The response may be a verbal output or a software action, performed by the UE 110 using processor 112, memory 113, display 114, speaker 115, one or more peripherals, or other modality.

### Architectures

ML models operate internally using embedded neural representations of information. This embedded neural representation is not legible to an outside observer. This internal or core embedded representation can be bookended by encoders and decoders. Encoders convert legible and symbolic inputs into the embedded neural representations, and decoders convert embedded neural outputs into symbolic or legible outputs. Accordingly, hereinafter, the term “symbolic” may describe a human-interpretable decoded representation of the internal operating language of the ML model. Embodiments herein can modify the operation of the ML model in between the encoders and decoders, by decoding the internal embedded representation of the model into a symbolic form and subsequently re-encoding it after manipulation. This enables greater control over the outputs generated by the ML model than in traditional training techniques.

According to several embodiments, utterances, actions, and/or state updates along with relevant knowledge from a Knowledge Graph (KG), are passed to an encoder, which generates a contextualized embedding of the current turn. That embedding is used to update a context and conversation history embedding, which represents the current conversational state. That conversational state is then monitored by a response policy, which decides appropriate action(s) and/or a natural language response for each conversational turn. A representation of that decision is then passed to a decoder, which generates action and NL response(s). These features will be described in further detail below, with reference to the drawings.

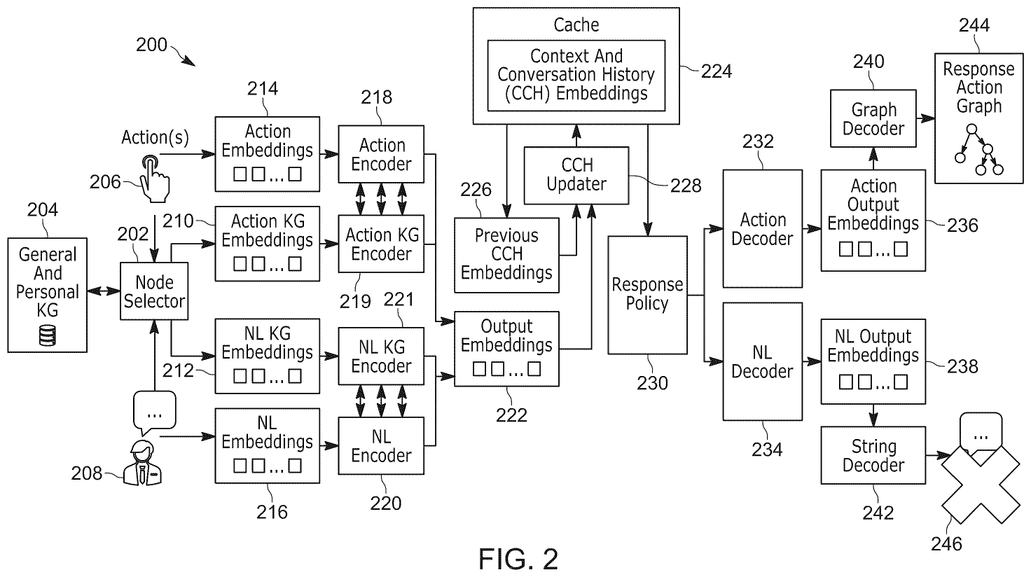

FIG. 2 is a block diagram of a method 200 according to one or more embodiments. The left side of FIG. 2 shows the encoder side of the architecture, and the right side of FIG. 2 shows the decoder side.

On the encoder side, a node selector 202 is used to choose which nodes from the Knowledge Graph (KG) 204 to include for any actions 206 and natural language 208 from the current conversational turn, and generate action KG embeddings 210 and natural language KG embeddings 212. Some embodiments, such as in FIG. 2 use the Knowledge Graph 204 at the input stage. KG 204 provides additional contextual information at the input stage in order to ground the ML model or large language model (LLM). In other words, information from KG 204 can constrain the outputs of the LLM in the subsequent stages and/or point it to a better output. KG 204 may include characteristics of the user, user equipment (UE), the user location, the inquiry or action itself, etc. In other words, KG 204 may be personalized to the user.

Action embeddings 214 and NL embeddings 216 can be generated directly from actions 206 and natural language 208, respectively. Embeddings can be considered an input broken into words or tokens to represent the input in a way that contains information about the input as a way of tracking meaning. The action encoders 218 and NL encoders 220 are then used to create output embeddings 222.

Output embeddings 222 are used to update the “Context and Conversation History” (CCH) embeddings 224, which maintains a representation of the conversational state, both from the current turn and any relevant conversation history. This is performed using previous CCH embeddings 226 and CCH updater 228. This update is triggered from any user action(s) and/or utterances, any action or NL responses from the model along with the results of any actions, and any external updates like the status of a connected device changing. Thus, the CCH includes an updated representation of all conversational context.

In a related art LLM, the CCH would be part of the input, instead of operating inside the LLM. This embodiment handles the instant input and combines it with the CCH inside model. By separating resolution part of dialogue from interpreting most recent information, the encoder does not have to analyze all of the previous information in the conversation. This helps specialize the components altering CCH inputs. In other words, embodiments herein are based on a chain of thought theory. They break down reasoning into components and analyze embeddings at each step in the CCH, instead of responding based on an entire conversation.

On the decoder side, when the CCH embeddings are updated, an RL-trained response policy 230 evaluates that state, and determines an appropriate response, if any. The response embeddings generated can include a representation of an action, an NL response, or both. A generated action response embedding may be decoded into an action graph (which can include a generalized action representation, API calls, etc) and any NL response embedding can be decoded into a natural language response. By maintaining a policy-monitored state, the model has the flexibility to learn when and how to respond.

In other words, action response embeddings are sent to the action decoder 232, and natural language response embeddings are sent to NL decoder 234. Action decoder 232 generates action output embeddings 236, and NL decoder 234 generates NL output embeddings 238. The action output embeddings 236 are sent to the graph decoder 240, and the NL output embeddings 238 are sent to the string decoder 242. Once the action output embeddings 236 are decoded by graph decoder 240, the decoded response is interpreted as a response action graph 244. The decoded NL output is sent as a response output for a virtual assistant 246.

Decoder and Encoder blocks can be any encoder/decoder modules from the literature including deep neural networks (DNNs), Graph Neural Networks, Recursive Neural Networks, Recurrent Neural Networks, Transformers, derivatives of those, etc.

Between the initial encoder blocks 218, 220 and the KG encoder blocks 219, 221 there is a mixing mechanism to allow each encoder to access the information of the other. This mixing mechanism can be any kind of information mixing methodology from the literature including concatenation, attention, DNNs, compositional recursive neural networks such as Tree-LSTMs, recurrent neural networks such as Stack LSTMs, pooling, etc.

The CCH updater 228 (and Current Turn Contextualizer 604 in subsequent embodiments) can also be any mixing mechanism mentioned above. The Response Policy 230 can be any reinforcement learning policy.

The Node Selector 202 can be any information retrieval algorithm, including deterministic methods (eg. fuzzy matching, etc), statistical methods (eg. TF-IDF, BM25, etc), and neural methods (eg. Embedding similarity methods, pointer networks, etc).

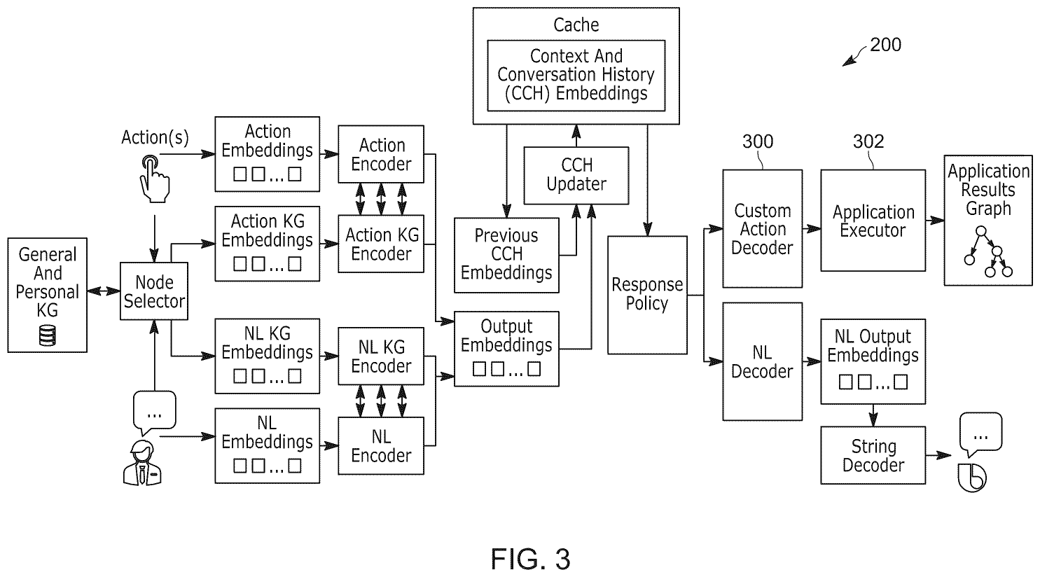

FIG. 3 shows one or more embodiments of the architecture. As in FIG. 2, model responses, model actions, model results and external state changes according to FIG. 3 are all encoded to update the context and conversation history (CCH) embedding, which the response policy will monitor in order to generate appropriate action and NL responses. FIG. 3 differs from FIG. 2 in that the ML algorithm is further modified to include a custom action decoder 300 and application executor 302. In other words, the difference for FIG. 3 is that the pretrained action decoder is replaced by a custom action decoder (for e.g. a virtual assistant) to generate application-executable outputs. This action decoder will be trained in the fine-tuning stage. This further constrains the software actions that can be taken by the algorithm, in order to prevent unwanted software actions by the virtual assistant.

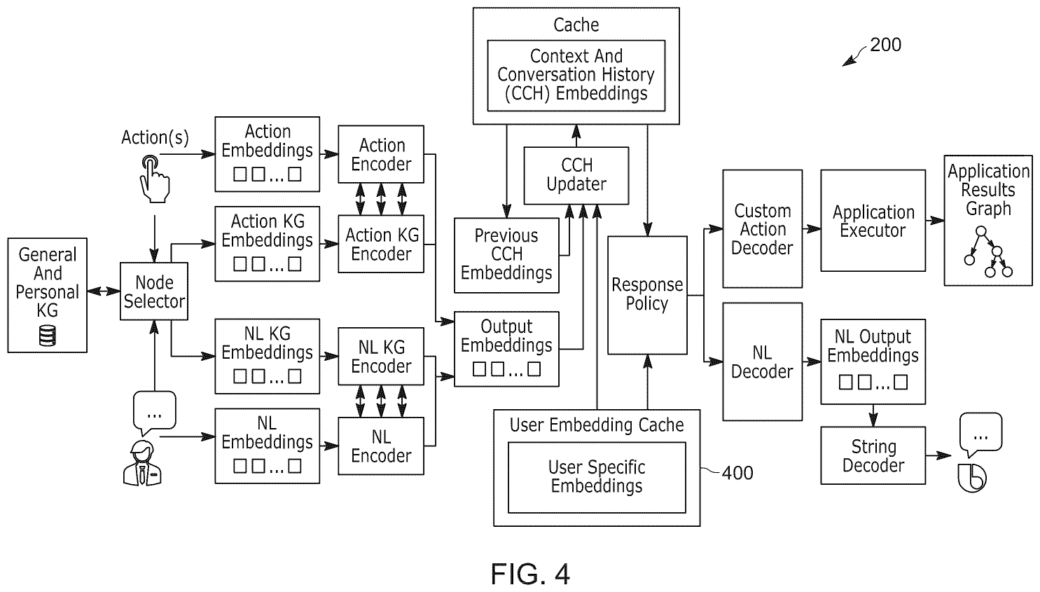

FIG. 4 shows one or more embodiments of the architecture. In FIG. 4, user-specific embeddings 400 are added that will be used by the CCH Updater and the response policy when generating responses. This allows for personalized responses to be generated based on learned usage patterns by a specific user. These embeddings can be fine-tuned for all users periodically (e.g. nightly).

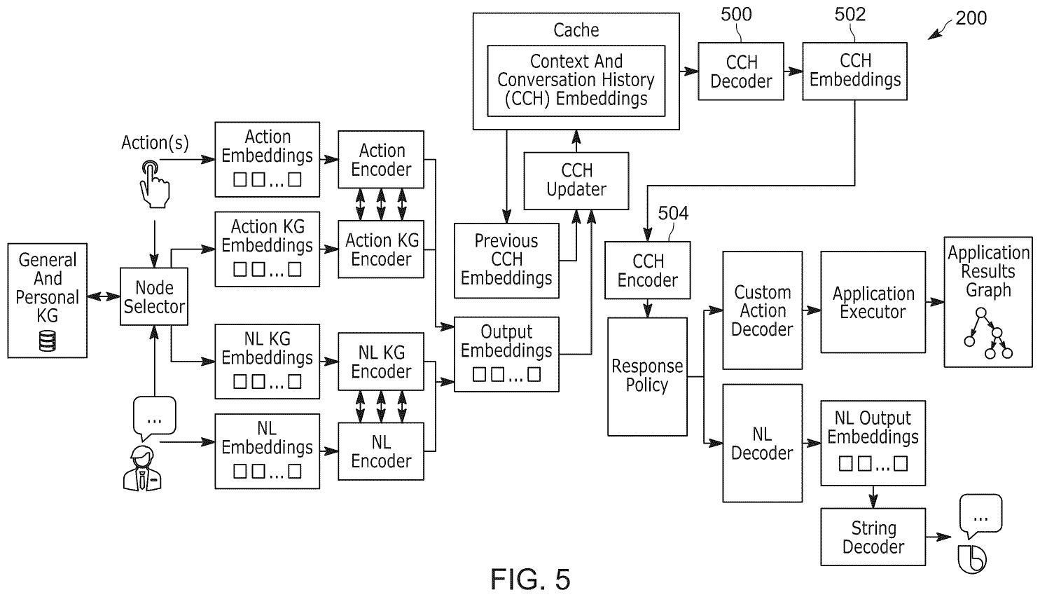

FIG. 5 shows one or more embodiments of the architecture. In FIG. 5, an additional fine-tuned decoder 500 and re-encoder 504 are added between the CCH embeddings 502 and the response policy 230. This breaks the continuous link between the encoder and decoder and acts as a filter, allowing the embeddings being used for decoding to be inspected, and aligned with pre-defined functionality. This feature may be used by business entities that desire more control over what responses are generated by the system.

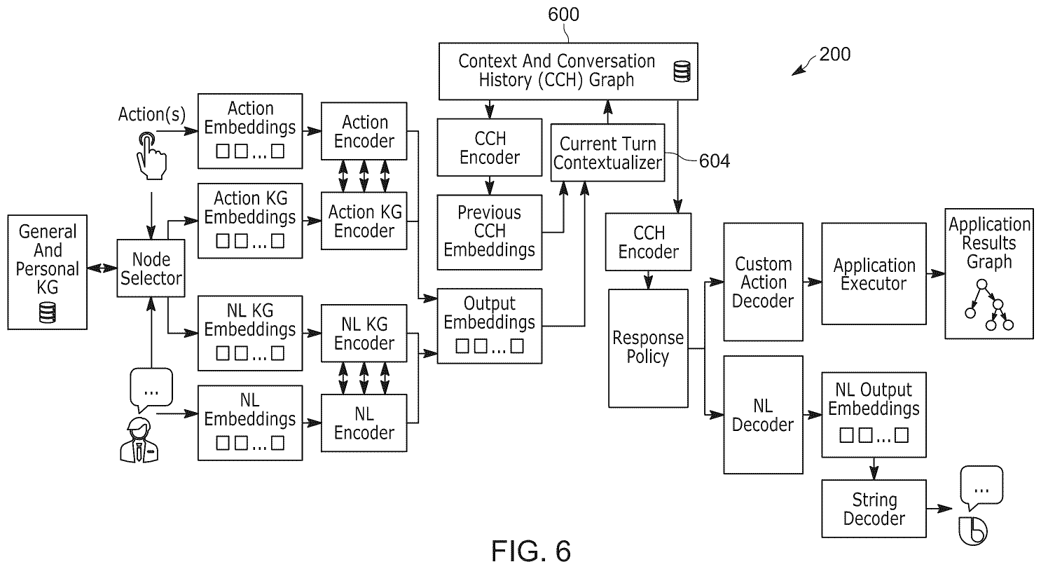

FIG. 6 shows one or more embodiments of the architecture. In FIG. 6, the continuous “Context and Conversation History” embeddings are replaced by a symbolic graph 600. This allows for direct state manipulation by external context updates. Contextualizing the encoder output embeddings for functions like anaphoric resolution is done with a “current turn contextualizer” module 604. This CCH graph 600 can be encoded and given to the response policy for response generation after each update.

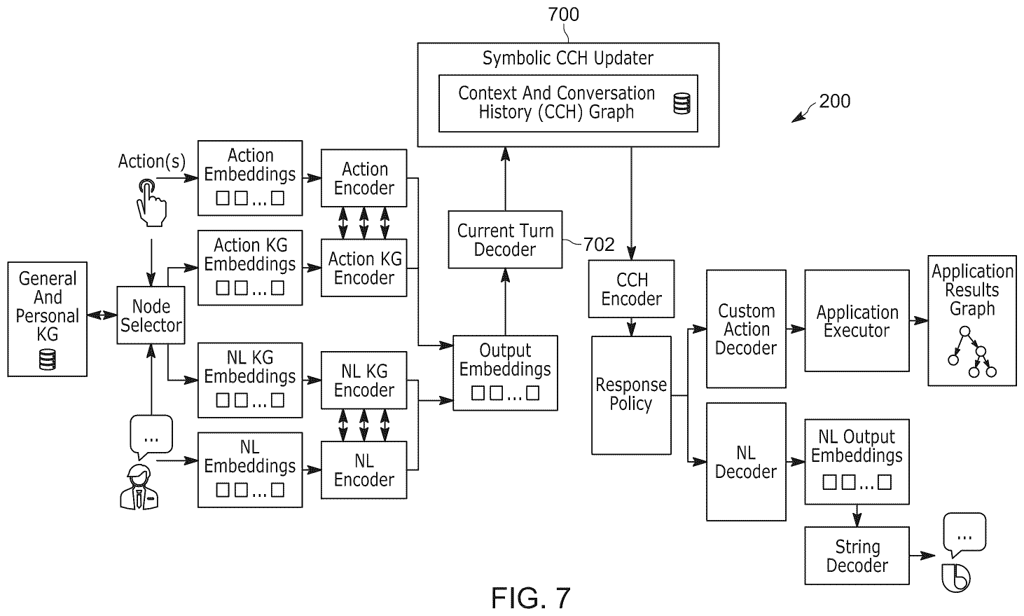

FIG. 7 shows one or more embodiments of the architecture. Like FIG. 6, in FIG. 7 “Context and Conversation History” is maintained in a symbolic graph, but here this is also wrapped in a symbolic system (symbolic CCH updater 700) in order to implement, e.g. anaphora resolution and graph updates symbolically, rather than using a neural contextualizer module. Response generation is still done with a response policy 230.

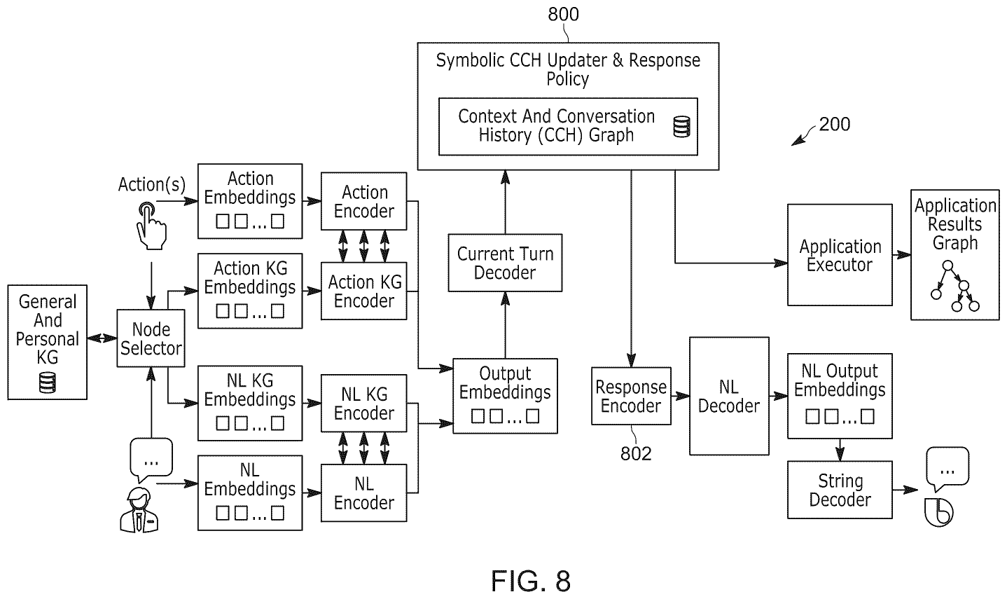

FIG. 8 shows one or more embodiments of the architecture. In FIG. 8, the response policy is also handled with a symbolic system. Encoding and decoding natural language and user actions is still done with the pre-trained encoders and decoder, but the dialogue management, resolutions (e.g. anaphoric), information and world state updates, action execution, and response planning is all done symbolically, using a deterministic state management algorithm. This is achieved using symbolic CCH updater and response policy 800 and response encoder 802.

### Training

The embodiments of the architectures herein can be further enhanced by training, to e.g. improve the results outputs of the ML models. Training the architecture can be done in 3 stages: Pre-training, Fine-tuning, and Reinforcement Learning. During pre-training on a large unsupervised corpus, no response policy exists. Instead, each example input generates an appropriate action and/or NL output, which is updated using modified loss functions.

During pre-training the following NL loss functions are used (from the literature): Masked Language Modeling (MLM), and Next Sentence Generation (NSG). During pre-training the following Action Loss Functions can be used: 1) Masked Action Modeling: Similar to MLM, but instead a part of an input action sequence is masked, and the model must predict the action(s) that fit into the masked location; 2) Next Action(s) Generation: using a sequence of input actions, performing training similar to NSG, but instead trying to predict the next action(s) that will take place given an action history. Additional pre-training techniques include: with a dataset of natural language descriptions of known actions, training the model to form similar representations and responses for corresponding input text and actions.

After pre-training, supervised fine-tuning can be performed. During supervised fine-tuning, example dialogue and action inputs are given to the model along with human constructed NL and action responses. The model is trained to generate responses similar to those examples. The approach for inference in FIG. 3 is shown above, though other embodiments could be trained analogously.

Finally, reinforcement learning (RL) is used to train the model end-to-end to generate human preferred responses (see next page), and to train the response policy to decide when and how to respond to given CCH embeddings. A simulated application executor is also used to generate action results. Since there is no human labeling involved, training can be done using actual user data.

A reward model must be trained before the RL training step, to provide feedback to the responses generated by the model policy. This can be trained as follows: 1) for all input examples, n output action and NL responses are generated using the dialogue-fine-tuned model; 2) human graders then rank combinations of those output actions and NL responses by preference, including an option to prefer no action and/or no NL response. Note that this is done for any inputs that update the “Context and Conversation History”, which include user utterances, user actions, model responses, result graphs, and external context updates; 3) these responses are then used to train a reward model to evaluate inputs by human preference, which is for use by the RL trainer. The RL trainer can utilize any known RL training mechanism.

### Processes

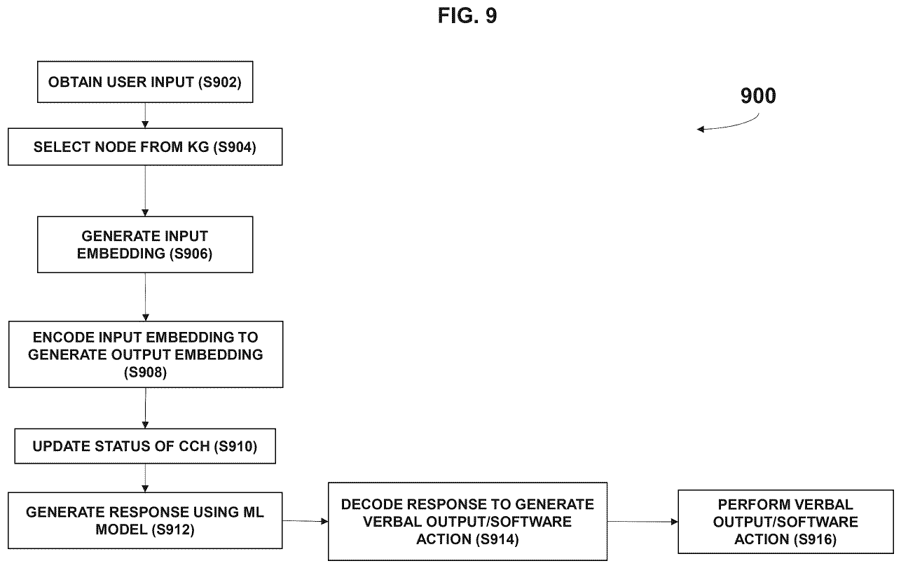

FIG. 9 shows a process according to one or more embodiments. Similar embodiments are shown in e.g. FIG. 2. Such a process may be used for implementing a virtual assistant. A user input is obtained, in the form of e.g. a verbal inquiry or action (S902). An example of a software action may be the user selecting an icon to take a specified action in a software environment (e.g. starting an application or selecting an option). An example of a verbal input may be an audible or text inquiry or information provided by a user.

In operation S904, relevant nodes are selected from KG 204. Based on the identity of user and the nature of the user input, information (e.g. nodes) is selected from the KG to contextualize the input. This information is combined with the inputs or actions to generate the KG embeddings (S906). The KG embeddings and regular input embeddings are then fed into the LLM. To do this, the embeddings are encoded to generate output embeddings (S908). In operation S906, the input information is converted to a format that can be processed by the LLM.

In operation S910, the output embeddings 222 are used by the LLM to update the status of the CCH 224. In this stage, the context and conversation history embeddings are updated based on the most recent user input, which have been converted to output embeddings 222. Performing this operation allows the algorithm to respond to each input individually, rather than analyzing the entire interaction between user and the LLM. This saves on computational resources and may improve output quality.

In operation S912, a response is generated using the ML model, based on a response policy 230. This response policy 230 can be set by an administrator or operator of the system (e.g. a virtual assistant). By setting the response policy 230, the outputs of the ML model can be constrained. The response policy 230 is a way for the administrator or operator to intervene at a core computational step of the ML model.

In operation S914, the response generated in S912 is decoded. Once generated in S912, the response is still coded for the ML model, and not legible to systems outside the ML model. In S914, the response is decoded to generate a legible output, which may be a verbal output and/or a software action. In operation S916, the verbal output or software action is performed. A verbal output could be e.g. a response to a user inquiry. A software action could be an initiation of a process requested by the user or calculated to address a user need.

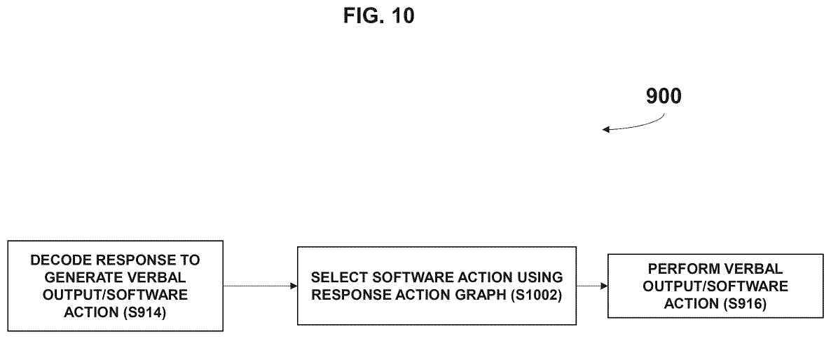

FIG. 10 shows one or more embodiments of a process. Similar embodiments are shown in e.g. FIG. 2. In FIG. 10, operation S1002 is performed between operations S914 and S916. In operation S1002, a software action is selected using a response action graph 244. Response action graph 244 is an abstract symbolic representation of an action. Decoded action outputs (generated in S914) in the form of a response action graph can be used to determine which software action(s) are the best response to the user input. For example, if the user input is “play my favorite radio station,” output may be to initiate a radio application playing what is known from the KG or elsewhere is the user's favorite radio station. The output response action graph 244 may lead the system to initiate such an action in operation S916.

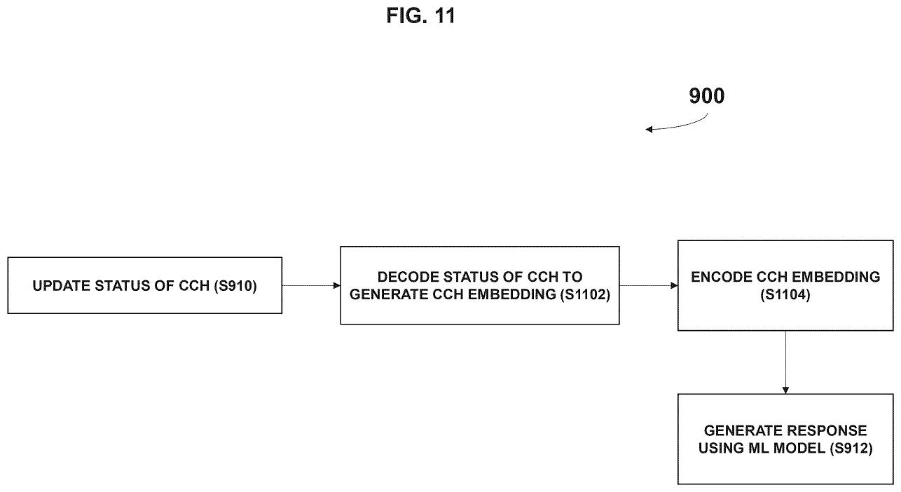

FIG. 11 shows one or more embodiments of a process. Similar embodiments are shown in e.g. FIG. 5. In FIG. 11, operations S1102 and S1104 are performed between operations S910 and S912. In operation S1102, the status of the CCH 224 is decoded to generate CCH embeddings. The CCH embeddings are then encoded again in step S1104, and used to generate a response using an ML model in operation S912. This breaks the continuous link between the encoder and decoder and acts as a filter, allowing the embeddings being used for decoding to be inspected, and aligned with pre-defined functionality. This feature may be used by business entities that desire more control over what responses are generated by the system.

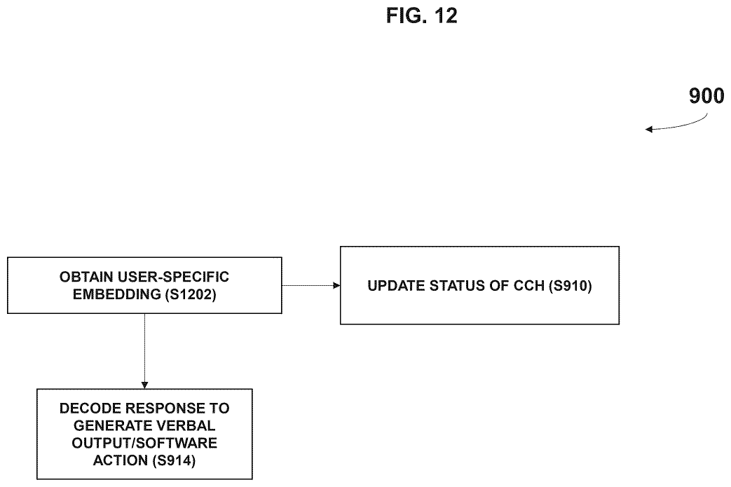

FIG. 12 shows one or more embodiments of a process. Similar embodiments are shown in e.g. FIG. 4. In FIG. 12, operation S1202 is performed prior to operations S910 and S914. In operation S1202, user-specific embedding are used to update the status of the CCH (S910) and generate the verbal output or software action (S914). This allows for personalized responses to be generated based on learned usage patterns by a specific user. These embeddings can be fine-tuned for all users periodically (e.g. nightly).

### Applications & Advantages

Embodiments described herein are also capable of performing generation tasks such as dialogue systems, question answering, and summarization. They can also be used to implement an enhanced virtual assistant using large language models. This enhanced virtual assistant may be capable of providing better responses than a human and initiate software applications (or take other software action) in response to user inputs.

An architecture such as this could be implemented in a personal assistant. This could provide numerous benefits over existing implementations, including: 1) more natural conversations, that flow like a conversation with another person or better; 2) natural generation of actions, that use the conversational state and context along with real world knowledge to appropriately address the user requests, even if not explicitly coded; 3) flexibility to easily tune the behavior of the assistant to align with the expectations of the service provider; 4) personalization of behavior and personality, based on user history, without needing to retrain the full architecture.

With knowledge and responses grounded in the real world and service provider policy, more truthful communication and better service provider oversight over response generation is possible.

Embodiments of the method and device described herein improve the functioning of a computer by improving quality of responses to verbal queries, conserving computational resources, and increasing speed. Moreover, they can generate better responses than a human and directly take-software based actions in response to user input (unlike a human). Also, by improving the operation of a software-based computer assistant, the operation of the computer itself is improved. These problems of computational waste, slow responsiveness, unpredictable outputs, and poor results are confined to the realm of computation and networks. Thus, embodiments herein are necessarily rooted in computer technology in order to overcome a problem specifically arising in the realm of computer networks.

Meanwhile, according to one or more embodiments of the disclosure, the various embodiments described above may be implemented with software including instructions stored in a machine-readable storage media (e.g., computer). The machine may call an instruction stored in a storage medium, and as an apparatus operable according to the called instruction, may include an electronic apparatus (e.g., electronic apparatus (A)) according to the above-mentioned embodiments. Based on a command being executed by a processor, the processor may directly or using other elements under the control of the processor perform a function relevant to the command. The command may include a code generated by a compiler or executed by an interpreter. The machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to one or more embodiments of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, according to one or more embodiments of the disclosure, the various embodiments described above may be implemented in a recordable medium which is readable by computer or an apparatus similar to computer using software, hardware, or a combination thereof. In some cases, the embodiments described herein may be implemented by the processor itself. According to a software implementation, embodiments such as procedures and functions described herein may be implemented with separate software modules. Each of the above-described software modules may perform one or more of the functions and operations described herein

Meanwhile, computer instructions for performing processing operations of the machine according to the various embodiments described above may be stored in a non-transitory computer-readable medium. The computer instructions stored in this non-transitory computer-readable medium may cause a specific device to perform the processing operations in the machine according to the above-described various embodiments when executed by the processor of the specific device. The non-transitory computer-readable medium may refer to a medium that stores data semi-permanently rather than storing data for a very short time, such as a register, a cache, a memory, or the like, and is readable by the machine. Specific examples of the non-transitory computer-readable medium may include, for example, and without limitation, a compact disc (CD), a digital versatile disc (DVD), a hard disc, a Blu-ray disc, a USB, a memory card, a ROM, and the like.

In addition, respective elements (e.g., a module or a program) according to various embodiments described above may be formed of a single entity or a plurality of entities, and some sub-elements of the above-mentioned sub-elements may be omitted or other sub-elements may be further included in the various embodiments. Alternatively or additionally, some elements (e.g., modules or programs) may be integrated into one entity to perform the same or similar functions performed by the respective relevant elements prior to integration. Operations performed by a module, a program, or other element, in accordance with the various embodiments, may be executed sequentially, in parallel, repetitively, or in a heuristically manner, or at least some operations may be performed in a different order, omitted, or a different operation may be added.

While certain embodiments of the disclosure has been particularly shown and described, it will be understood that various changes in form and details may be made therein without departing from the spirit and scope of the following claims.

What is claimed is:

1. A method of virtual assistance, the method comprising, using at least one processor:
obtaining an input from a user of a device;
selecting at least one node from a knowledge graph (KG) based on the input;
generating an input embedding based on the at least one node and the input;
encoding the input embedding to generate an output embedding;
updating a status of a context and conversation history cache (CCH) based on the output embedding;
generating a response based on the status, using a machine learning (ML) model;
decoding the response to generate at least one of a verbal output or software action; and
performing the at least one of the verbal output or the software action.

2. The method of claim 1, wherein the ML model is trained using reinforcement learning (RL).

3. The method of claim 1, wherein the input is a user action, and decoding the response generates the software action.

4. The method of claim 3, further comprising:
selecting the software action using a response action graph, based on the response.

5. The method of claim 1, wherein the encoding the input embedding and decoding the response are performed by at least one neural network.

6. The method of claim 1, further comprising:
decoding the status of the CCH to generate a CCH embedding; and
encoding the CCH embedding,
wherein the response is generated based on the encoded CCH embedding.

7. The method of claim 1, wherein the KG is personalized to the user.

8. The method of claim 1, further comprising:
obtaining a user-specific embedding from a user embedding cache,
wherein the updating of the status of the CCH is based on the user-specific embedding, and the response is generated based on the user-specific embedding.

9. The method of claim 1, wherein the software action is execution of a process in response to the input.

10. The method of claim 9, further comprising:
determining, based on the input, that the process would address a need of the user; and
executing the process.

11. A system for providing virtual assistance, the system comprising at least one server comprising:
at least one communication interface;
at least one processor; and
at least one memory storing instructions, that when executed by the at least one processor, cause the at least one processor to:
obtain an input from a user of a device, using the at least one communication interface;
select at least one node from a knowledge graph (KG) based on the input;
generate an input embedding based on the at least one node and the input;
encode the input embedding to generate an output embedding;
update a status of a context and conversation history cache (CCH) based on the output embedding;
generate a response based on the status, using a machine learning (ML) model;
decode the response to generate at least one of a verbal output or software action; and
send the verbal output or instructions to perform the software action to the device using the at least one communication interface.

12. The system of claim 1, wherein the ML model is trained using reinforcement learning (RL).

13. The system of claim 1, wherein the input is a user action, and decoding the response generates the software action.

14. The system of claim 3, wherein instructions further cause the at least one processor to:
select the software action using a response action graph, based on the response.

15. The system of claim 1, wherein the encoding the input embedding and decoding the response are performed by at least one neural network operating on the at least one server.

16. The system of claim 1, wherein instructions further cause the at least one processor to:
decode the status of the CCH to generate a CCH embedding; and
encode the CCH embedding,
wherein the response is generated based on the encoded CCH embedding.

17. The system of claim 1, wherein the KG is personalized to the user.

18. The system of claim 1, wherein instructions further cause the at least one processor to:
obtain a user-specific embedding from a user embedding cache,
wherein the updating of the status of the CCH is based on the user-specific embedding, and the response is generated based on the user-specific embedding.

19. The system of claim 1, wherein the software action is execution of a process in response to the input.

20. The system of claim 9, wherein instructions further cause the at least one processor to:
determine, based on the input, that the process would address a need of the user; and
execute the process.
